(19) United States
(12) Patent Application Publication
(10) Pub. No.: US 2005/0255147 A1
(43) Pub. Date: Nov. 17, 2005

(54) Composition for dietary enrichment

(75) Inventor: Mark Geach, London (GB)

Correspondence Address: NIXON & VANDERHYE, PC, 901 NORTH GLEBE ROAD, 11TH FLOOR, ARLINGTON, VA, 22203, US

(73) Assignee: ZOOLIFE INTERNATIONAL LIMITED, London (GB)

(21) Appl. No.: 10/524,493

(22) PCT Filed: Aug. 14, 2003
(86) PCT No.: PCT/GB03/03553

§ 371 Date: Jun. 8, 2005

(30) Foreign Application Priority Data
Aug. 14, 2002 (GB) 0218932.2

(51) Int. Cl. A23K 1/165; A23K 1/17

(52) U.S. Cl. 424/442; 426/635

(57) ABSTRACT

The present invention relates to a composition comprising one or more carotenoid, an aqueous diluent, and one or more of the following substances: vitamins, minerals, amino acids, fats or polysaccharides, wherein the composition is in the liquid state. In particular, the composition is for enriching animals' dietary intake. The invention also includes enriched feed and methods for enriching feed.

The present invention relates to compositions for enriching animals' dietary intake. Compositions of this type are particularly useful for enriching animal feed, in particular, feed for fish, crustacea and poultry. The invention includes enriched feed and methods for enriching feed.

Animals that are kept as pets, in zoos or that are used in the farming industry are kept captive, away from their natural habitat. One of the inherent problems with keeping animals in such an environment is the need to provide them with a diet that adequately reflects the nutritional diversity and bioavailability of their natural diet. Failure to provide the proper dietary requirements results in negative effects on growth, reproduction, health and sustainability of a captive population.

The basic nutrition for captive species is normally provided by live or dead (whole or part) animals, plant matter, or a variety of processed feeds that may come in a variety of forms, such as pellets, flakes, biscuits etc.

However, a diet based purely on such food is often not sufficient to provide an animal with its total dietary requirement. Additionally, harvesting, processing, manufacture and storage of food can lead to a reduction in the nutritional value of the food. Exposure to light, heat, pressure, mechanical actions, atmospheric conditions or irradiation also damages feed ingredients resulting in reduced quantities of nutrients and/or reduced bioavailability of important dietary components. Nutrients that may be affected include fats, vitamins, and carotenoids. For example, the most commonly used frozen marine feeds (TMC Brineshrimp and Mysis) generally have poor pigment profiles due to processing and as such need supplementing with an external carotenoid source.

Every species requires a full complement of their essential vitamins, minerals, fatty acids and amino acids in their diet, in addition to energy which can be derived from polysaccharides or lipids. Maintaining a proper dietary balance of, for example, fat and protein is essential for health of animals.

Minerals are required in the diet of many species for use in a number of biological processes involving metalloenzymes, neurotransmitters, oxygen carrying compounds, and skeletal structure.

Lipids are required not only as an energy source but also are essential for the synthesis of phospholipids, steroids and structural elements in cell walls.

Carotenoids are also considered to be an important dietary component for many species. Carotenoids are pigments that are known to act as powerful antioxidants. Certain carotenoids are additionally known to provide pigmentation and coloration of animal tissues. For example, a red carotenoid pigment can be added to the diet of broiler chickens to colour the shanks, and to the diet of farmed trout to produce the same brightly coloured flesh as seen in wild trout.

Peptides and nucleotides have been shown to increase nutrient and drug absorption and lead to beneficial effects in growth rates and health. Peptides and nucleotides are also known to alter the absorptive area of the intestinal mucosa in fish.

Accordingly, it is common to supplement basic feeds with a number of additional substances.

However, conventional supplements do not properly counter deficiencies in the basic feed of the animals, often not providing the proper range and composition of components required for a balanced diet. Components of the supplements have also been shown to have a low level of bioavailability and so are of little worth in enriching the diet of an animal.

Thus, it is an object of the present invention to develop a composition for use in enriching an animal's diet that does not possess the aforementioned disadvantages of previously identified compositions.

It has been surprisingly discovered that the composition of the present invention provides an enhanced level of enrichment of an animals diet, as well as providing a high level of bioavailability. The general health of an animal ingesting feed enriched by the inventive composition has been shown to improve, including an improvement in healing and reduction in pathogen loading. For example, veterinary records for fish receiving feed enriched with the composition show a reduction in the prevalence of pathology and diseases affecting the skin. Also noted in clinical assessments of such fish is a noticeable reduction in pathogen loading within the mucous coat of the skin and fins and an increase in tissue healing rates.

Additionally, the composition affords stability to the active components during storage, application and the post application period. The composition can be stored for over 18 months at typical storage temperatures for such products ensuring target enrichment of feed at all stages of the product life. Additionally, this composition is stable when incorporated into feed for longer than current commercially available feed enrichment products such as Carophyll Pink CWD.

Accordingly, in a first aspect of the present invention, there is provided a composition comprising one or more carotenoids, and one or more of the following substances: vitamins, minerals, amino acids, lipids, peptides, nucleotides and/or polysaccharides.

A particular surprising advantage of such compositions is the ability, when incorporated in an animal's diet, to maintain and/or restore natural skin colour and health in the animal. It is conventional for feed supplements to be added to feed in order to alter the colour of the flesh. However, maintaining or restoring colour to the skin of the animal by supplementing the animals feed has always proven to be difficult in the past.

It is know that fish provided with traditional synthetic carotenoid sources do not develop or maintain full natural skin coloration, lustre and health. As an example, clown fish fed on a granulated diet containing 1000 mg/kg synthetic astaxanthin do not to significantly alter skin coloration as compared to fish fed on their standard base diet. However, it has been shown that when the clown fish diet is supplemented with the compositions of the present invention the skin colour and definition of skin colour regions is dramatically improved. Amazingly, this improvement was noted at carotenoid levels of below 50 mg/kg (astaxanthin weight/final feed weight).

In a number of cases, skin colour and health have been noted by veterinary and visual examination to have significantly improved within two weeks of commencement of feed supplementation. Natural colour enhancement has been noted without specific colours being limited. Good long term fish health, colour maintenance and restoration of deficient colour have been noted at food enrichment levels of between 4 and 12 mg/kg astaxanthin in enriched feed.

A similar enhancement of colouration has been found in invertebrates and reptiles.

This composition may be prepared for administration in a number of ways.

For example, the composition may be given directly in the liquid form, as an encapsulated liquid preparation, or incorporated in the feed in liquid form.

Thus, in a further preferred embodiment, the composition comprises an aqueous diluent and is preferably in the liquid state.

It should be understood that any aqueous diluent may be used that could be ingested, without experiencing toxic effects, by the species that is intended to consume the composition. Preferably, the aqueous diluent is water, most preferably the aqueous diluent is purified water.

It has been found that the liquid form of composition is particularly effective, especially when given as an encapsulated liquid or added directly to enrich feeds.

Encapsulation techniques are known in the art and may comprise a central reservoir of the composition surrounded by a protective capsule, the matrix of the capsule preferably contains antioxidants.

The direct enrichment of feed is achieved by adding the composition to feeds during or post manufacture, harvesting, processing, or delivery to the consumer.

Conventionally, dry powdered vitamin, mineral, carotenoid and amino acid etc. preparations are used to enrich feeds. However, the use of such preparations has a number of distinct disadvantages.

It is virtually impossible to produce uniformly enriched foods using such powdered particles, or fine aggregates. These preparations have a low level of adherence to the feed. Since the powdered particles tend to be small in comparison to the feed, the preparations are susceptible to post enrichment settlement, thereby producing a variance in feed quality, especially following storage, transport and distribution.

These enrichment compositions also suffer from the same problems as the basic feed, in that exposure to light, heat, pressure, mechanical actions, atmospheric conditions or irradiation can damage compositions, thereby reducing the value of the enrichment.

It has been found that liquid compositions simplify the enrichment process, provide an enhanced uniform distribution and adherence to the feed, as well as providing a high level of bioavailability. Additionally, the composition affords stability to the active components during storage, application and the post application period.

In a preferred embodiment one or more of the components of the composition are water soluble.

In a further preferred embodiment one or more of the components of the composition are fat soluble. Preferably, the fat soluble components are provided in micelles.

It has been found that the ability to enrich feed with the composition of the present invention can be enhanced by providing the composition in the form of an emulsion or dispersion. In particular it has been shown that providing one or more of the fat soluble components (particularly carotenoids) of the composition in the form of a micelle allows a convenient and highly efficient preparation for administering the composition. Not wishing to be bound by theory, it would appear that the micelle structure offers a high level of stability for the lipid soluble components and high level of absorption and retention in the feed because of the micelle structure having a high affinity for fats in the feed, thereby ensuring the composition is not lost from the feed. This is particularly important when the enriched feed is delivered to the target animal in an aquatic environment.

The absorption and retention of such compositions is particularly evident in crustaceans where a high level of unsaturated fats including waxy esters are present. A good level of absorption and retention of the composition by feed such as live juvenile crustacea is particularly important since such feed do not have developed mouth parts and so can not depend on ingestion to load the composition with the body.

Accordingly, in a preferred embodiment of the current invention, when the composition comprises an aqueous diluent and is in the liquid state the fat soluble components are in the form of micelles.

However, the liquid form is not the only form the composition may take.

In a further preferred embodiment of the invention, the composition is formed into a tablet, or microencapsulated preparation, preferably these compositions do not contain a liquid diluent. Microencapsulated preparations are known in the art and usually comprise a core of the composition covered by a protective matrix, preferably the matrix includes antioxidants. The tablet or microencapsulated preparation may either be ingested in isolation from the feed or ingested along with feed. Often it is desirable to hide the tablets or microencapsulated preparations or tablets in the feed so that the animal unknowingly ingests the tablet. The tablet or microencapsulated product may also be prepared for dissolving in a liquid diluent prior to ingestion.

The choice of carotenoid, vitamin, mineral, amino acid, lipid, peptide, nucleotide or polysaccharide is dictated by the particular species and age of the animal intended to ingest the composition, and the deficiencies in their diet. Accordingly, the skilled person would be able to determine the appropriate carotenoid, vitamin, mineral, amino acid, lipid, peptide, nucleotide or polysaccharide in these specific circumstances.

Not wishing to be limited further, but in the interests of clarity, the following are examples of suitable components of the compounds of the invention.

Examples of suitable carotenoids are those derived from yeast (e.g. Phaffia rhodozyma) or algae (e.g. Haematoccocus algae), extracted from oleoresins, lucantin pink or astaxanthin glucosides. Preferably the carotenoid is astaxanthin esterified to fatty acid acyl groups, such carotenoids show surprising absorption properties, particularly in feeds containing high lipid levels (e.g. krill, mysis and brineshrimp). Preferably the water soluble carotenoid is an astaxanthin glucoside. When coloration of the target animal is required specific carotenoids may be chosen in order to enhance specific colours.

Examples of suitable vitamins are A, B1, B2, B6, B12, C (vitamin C may be included as ascorbyl polyphosphate), D, E, K, Nicotinamide, Choline, Inositol, folic acid and Biotin. Preferably, the fat soluble vitamins are A, D, E and K. Preferably, the water soluble vitamins are C, B1, B2, B6, B12, Nicotinamide, Choline, Inositol, folic acid or Biotin.

Examples of suitable minerals are iodide, iron, manganese, calcium, phosphorous, sodium, potassium, magnesium, zinc, copper or selenium.

Preferably, the amino acids are the essential amino acids for the animal that is to ingest the composition. However, non-essential amino acids are also contemplated for inclusion in the composition of the invention since it has been shown that their inclusion reduces the quantitative requirement for essential amino acids. For example, the essential amino acids for salmonid fish, and appropriate for including in the composition of the invention, are arginine, histidine, isoleucine, leucine, lysine, methionine phenylalanine, threonine, tryptophan and valine. Non-essential amino acids cysteine and tyrosine ate also suitable amino acids. It has been shown in salmonid fish that cysteine can replace up to a third of the required methionine and tyrosine can replace up to a fifth of the required phenylalanine. Some amino acids have also been shown to act as feeding behaviour modifiers. For example, in carnivorous fish the following compounds have been shown to alter feeding responses: glycine, proline, taurine, valine, betanea and inosine. These amino acids are also contemplated as being suitable for inclusion in the claimed composition.

A variety of lipids and lipid derived compounds may be included in the composition. Preferably, the lipids are fats and more preferably oils which may be added along with one or more carotenoid as an oleoresin. A balanced addition of oils of suitable chain length have been found to aid enrichment. However, the lipids may also be fatty acids, triglycerides, phospholipids and other neutral lipids such as alkyldiacylglycols, sterol esters, wax esters and pigments. Examples include but are not restricted to: phosphatidylcholine, phosphatidylethanolamine, phosphatidylserine, phosphatidylinositol, plasmalogens, sphingomyelin, cerebrosides and gangliosides.

Thus, essential fatty acids may be added to the composition. Fish and terrestrial mammals do not possess the desaturase enzymes necessary to synthesize 18:2ω6 or 18:3ω3 fatty acids and so these fatty acids must be added to the diet to maintain cellular function and normal growth.

Waxy esters or their precursors may be added to the composition to increase the availability of these important dietary components in some species. Waxy esters are esters of a fatty acid and a long-chain fatty alcohol. Crustaceans and some fish contain high levels of wax esters such as those comprising fatty acids esterified to hexadecanol. Therefore, the composition would preferably include wax esters comprising fatty acids esterified to hexadecanol.

The lipids may be included from a variety of chain lengths, preferably C14-C25. These may include but are not restricted to; C14, C16, C18, C20, C22, C25.

Examples of lipids which may be added to the composition include but are not restricted to; 14:0, 16:0, 16:1, 18:0, 18:1ω9, 18:2ω6, 18:3ω3, 18:4ω3, 20:1ω9, 20:4ω6, 20:4ω3, 20:5ω3, 22:1ω9, 22:5ω6, 22:5ω3, 22:6ω3.

The lipids used may be derived from animal or plant sources, or may be artificially synthesized.

Preferably, when the composition comprises a liquid diluent or the composition in tablet form is dissolved in a liquid diluent, the composition forms an emulsion or dispersion. Such compositions have an aqueous phase, which may contain one or more of the following; water soluble vitamins, minerals, carotenoids, amino acids, peptides, nucleotides and polysaccharides. Any one of lipids, fat soluble vitamins, carotenoids, minerals, peptides, nucleotides and amino acids may be contained in micelle or “microencapsulated” form, preferably distributed evenly throughout the composition. The presence of the micelles has been shown to aid the uptake of fats and fat soluble vitamins, carotenoids and amino acids from the diet at the level of the digestive tract. This, combined with the simultaneous presentation of water soluble vitamins, minerals, peptides, nucleotides, polysaccharides carotenoids and/or amino acids, has a synergistic effect on the bioavailability of the composition. Preferably, the emulsions or dispersions are formed by high speed blending.

The high level of bioavailability is partly due to the fact that there is a reduced potential for chemical interactions in such preparations. Indeed, it has been noted that there is a reduction in the oxidation of vitamins and carotenoids of these liquid compositions in the post application stage.

In a further preferred embodiment the composition comprises one or more water soluble vitamins and one or more fat soluble vitamins.

In a further preferred embodiment the composition comprises one or more water soluble carotenoids and one or more fat soluble carotenoids.

In a further preferred embodiment the composition comprises one or more water soluble amino acids and one or more fat soluble amino acids.

In a further preferred embodiment the composition comprises one or more water soluble minerals and one or more fat soluble minerals.

In a further preferred embodiment the composition comprises one or more water soluble peptides and one or more fat soluble peptides.

In a further preferred embodiment the composition comprises one or more water soluble nucleic acids and one or more fat soluble nucleic acids.

The polysaccharide is preferably a non-starch polysaccharide and most preferably a glucan. Preferably, 1,3 β-glucan, or 1, 6 β-glucan are contemplated since it has been shown that these molecules have a non-specific immunomodulatory role, particularly in fish physiology.

Cellulose, gum and sugar derivatives may be added to the composition to aid dispersion within or onto feeds by virtue of their ability to increase solution viscosity and adherence. These, however, are not essential and are not required for emulsification of this composition. Indeed, in the absence of such cellulose, gum or sugar derivatives, the composition is still capable of adhering surprisingly well to feed. Thus, a preferred composition of the invention does not contain gum, cellulose, sugar and/or dextrin.

Gelling agents, or combinations of gelling agents, may also be included in the composition so as to form a gel preparation. Suitable gelling agents would be known in the art, such as locust bean gum, zanthan gum, natural binding agents derived from plants or algae, pectins, starch, cellulose derivatives such as carboxy-methyl-cellulose, gelatine, agar, or carrageenan.

The composition may additionally include one or more emulsifier, one or more antioxidants other than a carotenoid, one or more preservatives, one or more stabilising agents and/or one or more particulate materials.

The emulsifying agents, such as Polysorbate 80, help in the formation of the micelle “microencapsulated” fat soluble components. Alternatively, or in addition, the micelles may be formed by high speed blending.

The inclusion of stabilising agents, such as monopropylene glycol, in the composition help stabilise the fat soluble components and optimise micelle distribution. The use of such stabilising agents reduces potential for product turbidity and affords excellent product clarity.

Preservatives, such as phosphoric acid or potassium sorbate, may be included in the composition to preserve the composition by preventing the growth of bacteria, fungi and yeasts.

The addition of antioxidants to the composition aids stability. Examples of suitable antioxidants include ascorbyl polyphosphate and butylated hydroxy-toluene. Antioxidants prevent or minimize the loss of the active components of the composition, thereby extending the shelf life of the composition and providing protection to the finished product in the post application phase.

The particulate material may take the form of an inert particulate or can be formed from one or more of the carotenoids (e.g. from Phaffia rhodozymax or Haematoccocus algae), vitamins, minerals (such as selenium), beta glucans, or peptides of the composition. These particles may act as carriers for the other components of the composition and have been shown to be particularly effective at absorbing components of the composition that are prepared in micelle form.

Compositions of this sort are particularly preferred for enriching live feed that are capable of ingesting the particulate matter (e.g. 12 hour post hatching artemia or mysis and daphnia). Such feed are capable of loading their gastrointestinal tract lumen with the composition where it is not immediately subjected to biochemical breakdown.

It is preferred that the substances for inclusion in the composition can be ingested, without experiencing any toxic effects, by the species that is intended to consume the composition.

In a further preferred embodiment of the invention, the inclusion of one or more carotenoid in the composition is optional.

It should be realised that the amounts of carotenoid, vitamin, mineral, amino acid, lipid, peptide, nucleotide or polysaccharide as well as emulsifier, antioxidant, preservative and stabilising agent are dictated by a number of functions, namely the form of preparation (dry, fluid, encapsulated), the particular species and age of the animal intended to ingest the composition, and the deficiencies in their diet. Accordingly, the skilled person would be able to determine the appropriate amounts in these specific circumstances.

Not wishing to be limited further, but in the interests of clarity, the following are examples of suitable ranges for the amounts of components present in the compounds of the invention.

Carotenoids may be present in between 0-99, 0-95, 0-85, 0-80, 50-95, 80-95, 0-25, 0-10, 0-5, 0.1-1, 0.001-1, or 0.0001-1% Wt/Wt of the composition, not including any aqueous diluent.

Vitamins may be present in between 0-99, 0-95, 0-85, 0-80, 50-95, 80-95, 0-25, 0-10, 0-5, 0.1-1, 0.001-1, or 0.0001-1% Wt/Wt of the composition, not including any aqueous diluent.

Minerals may be present in between 0-99, 0-95, 0-85, 0-80, 50-95, 80-95, 0-25, 0-10, 0-5, 0.1-1, 0.001-1, or 0.0001-1% Wt/Wt of the composition, not including any aqueous diluent.

Amino acid may be present in between 0-99, 0-95, 0-85, 0-80, 50-95, 80-95, 0-25, 0-10, 0-5, 0.1-1, 0.001-1, or 0.0001-1% Wt/Wt of the composition, not including any aqueous diluent.

Lipids may be present in between 0-99, 0-95, 0-85, 0-80, 50-95, 80-95, 0-25, 0-10, 0-5, 0.1-1, 0.001-1, or 0.0001-1% Wt/Wt of the composition, not including any aqueous diluent.

Peptides may be present in between 0-99, 0-95, 0-85, 0-80, 50-95, 80-95, 0-25, 0-10, 0-5, 0.1-1, 0.001-1, or 0.0001-1% Wt/Wt of the composition, not including any aqueous diluent.

Nucleotide may be present in between 0-99, 0-95, 0-85, 0-80, 50-95, 80-95, 0-25, 0-10, 0-5, 0.1-1, 0.001-1, or 0.0001-1% Wt/Wt of the composition, not including any aqueous diluent.

Polysaccharide may be present in between 0-99, 0-95, 0-85, 0-80, 50-95, 80-95, 0-25, 0-10, 0-5, 0.1-1, 0.001-1, or 0.0001-1% Wt/Wt of the composition, not including any aqueous diluent.

Emulsifier may be present in between 0-55, 0-65, 0-45, 0-35, 0-25, 0-10, 0-5, 5-10, 5-20, 10-30, 20-40, 0.01-1, 0.001-1, or 0.0001-1% Wt/Wt of the composition, not including any aqueous diluent.

Antioxidant may be present in between 0-55, 0-65, 0-45, 0-35, 0-25, 0-10, 0-5, 5-10, 5-20, 10-30, 20-40, 0.01-1, 0.001-1, or 0.0001-1% Wt/Wt of the composition, not including any aqueous diluent.

Preservative may be present in between 0-55, 0-65, 0-45, 0-35, 0-25, 0-10, 0-5, 5-10, 5-20, 10-30, 20-40, 0.01-1, 0.001-1, or 0.0001-1% Wt/Wt of the composition, not including any aqueous diluent.

Stabilising agents may be present in between 00-99, 0-95, 0-85, 0-80, 50-95, 80-95, 0-25, 0-10, 0-5, or 0.0001-1% Wt/Wt of the composition, not including any aqueous diluent.

As discussed above, some compositions of the invention do not include an aqueous diluent. The other compositions that do contain an aqueous diluent may contain 10, 9, 8, 7, 6, 5, 4, 3, 2, 1, 0.9, 0.8, 0.7, 0.6, 0.5, 0.4, 0.3, 0.2, 0.1, 0.09, 0.08, 0.07, 0.06, 0.05, 0.04, 0.03, 0.02, 0.01, 0.001 or 0.0001 litres of diluent per 1 kg of the other components of the composition.

The compositions of the invention are particularly useful as they can be used to enrich a diet in a multitude of ways, allowing the method of enrichment to be chosen so as to best accommodate the species, or basic feed of choice.

Thus, in a preferred embodiment the composition is used for enriching the diet of a captive species. Preferably the captive species are fish and more preferably the captive species are farmed fish, ornamental fish or aquarium fish.

In a further preferred embodiment the composition is incorporated in feed, examples of the method of incorporation are given below.

The composition can be added to feeds during or post manufacture, harvesting, processing, or delivery to the consumer. Examples of suitable feeds are; fish, crustaceans, artemia, copepods, mysis, krill, polychetes such as ragworm and lugworm, and farmed insects such as crickets, mealworms and locusts. These feeds are particularly useful as feeds for fish and reptiles. The composition may also be fed to the animal in isolation from other food.

Thus, in accordance with a second aspect of the present invention, a composition in accordance with the first aspect is used in a method for enriching feed by soaking the feed in the composition. In a preferred embodiment the feed is defrosting or defrosted. Alternatively, the feed is soaked in the composition prior to freezing. This method has been shown to provide surprising levels of absorption and retention of the composition in feed. Even after soaking in a liquid formulation of the composition for as little as 30 minutes, followed by salt water washing, feed such as krill, mysis and brineshrimp have been shown to retain the composition.

Generally longer periods of soaking provide better absorption and retention of the composition in the feed. Accordingly, by controlling the length of time the feed is soaked for, the user may control the amount of composition retained in the feed.

Soaking artemia in the composition six hours after hatching has been shown to significantly increase the lipid content of the artemia. This is important as the lipids are vital in the provision of nutritional requirements of juvenile animals. The person skilled in the art would be aware how to adapt the lipid profile of he invention to suit the individual needs of the target animal.

In accordance with a third aspect of the present invention, a composition in accordance with the first aspect of the invention is used in a method for enriching feed by spraying the feed with the composition. The composition may be sprayed onto feed such as processed feeds (for example, extruded pellets) or the exoskeleton of invertebrates (such as crickets, or locusts). Greater penetration of the feed may be achieved by using a pressure spray.

In accordance with a fourth aspect of the present invention, a composition in accordance with the first aspect of the invention is used in a method for enriching feed by adding the composition before or during production of processed feed. In this way the composition is mixed through the feed whilst the feed itself is being produced. This method of enrichment is preferably carried out prior to extrusion and shaping and/or prior to freezing of the processed feed. Greater penetration of the feeds may be achieved in the second, third and fourth aspect of the present application by applying a vacuum to the enriched feed or carrying out the method in a pressure vessel.

In accordance with a fifth aspect of the present invention, a composition in accordance with the first aspect of the invention is used in a method for enriching feed by injection of the composition into the feed. This method is particularly useful for enriching feed in the form of fish for sharks and rays.

In accordance with a sixth aspect of the present invention, a composition in accordance with the first aspect of the invention is used in method for enrichment of feed by adding the composition to the environment or diet of live feed. In this way the live feed will either be coated in the composition, or absorb or ingest the composition, thereby enriching the gut and body tissue of the live feed. If the live feed is an aquatic species the composition may be added to the water in which the live feed are contained.

The composition may also be added to the environment of the animal intended to benefit from the composition. For example, if the animal is an aquatic species the composition may be added to the water in which the animal is contained. Thus, the animal will either ingest or absorb the composition.

In accordance with a seventh aspect of the present invention, a feed comprising a composition in accordance with a first aspect of the invention is contemplated.

It has been found that the compositions of the present invention provides a protective environment for the feed during and after the enrichment process. For example, mysis shrimp typically degrades in 2-3 hours after defrosting. After enrichment with the composition, the treated mysis shrimp may be stored for 8-12 hours. This obviously increases the ease of feeding as a single batch of feed can be defrosted, enriched and stored for feeding to the animals throughout the day. Without this composition feed would have to be prepared periodically throughout the day.

Feed may be pre-treated with enzymes such as proteases and/or lipases prior to the enrichment of the feed with the composition (this is particularly effective for those methods that involve soaking or spraying of the feed). Such enzymes alter the surface structure of feeds to allow more efficient enrichment by the composition of the present invention. Alternatively the composition may comprise aforementioned enzymes and the aforementioned pre-treatment step may be dispensed with.

The pH of the composition may also be varied in order to optimise the enrichment of specific feed.

The composition may be prepared in a kit form which could optionally comprise enzymes and/or feed. Alternatively the enzymes and/or feed my be provided in discreet portions.

The kit may include a vacuum or pressure device in order to further assist the enrichment process. In a preferred embodiment the packaging of the kit includes such a device so that the enriched feed may be easily prepared under pressure or in a vacuum within the packaging.

Specific compositions according to the present invention will now be described, by way of example only.

### EXAMPLE 1

| Material | % (Wt/Wt) |
|---|---|
| Phosphoric Acid (85% Food Grade) | 2.6386 |
| BHT P/L | 0.0264 |
| Monopropylene Glycol BP/000 (P/L) | 79.1583 |
| Polysorbate 80 (Alkamuls T80) | 13.1930 |
| Potassium Sorbate Powder BP | 2.6386 |
| Potassium Iodide BP-USP (Nutec) | 0.0007 |
| Panthenol-D (P/L) | 0.0066 |
| Vitamin A Propionate 2.5 MIU | 0.0165 |
| Vitamin D3 Oil 4 MIU-G (P/L) | 0.0007 |
| Vitamin K | 0.0063 |
| Biotin USP Pure | 0.0007 |
| Choline Chloride 05 BP | 0.0132 |
| Inositol (P/L) | 0.0007 |
| Nicotinamide (Nutec - P/L) | 0.0693 |
| Para-Amino-Benzoic Acid (P/L) | 0.0660 |
| Pyridoxine Hydrochloride (Nutec - P/L) | 0.0073 |
| Vitamin B1 (Thiamine HCL) (P/L) | 0.1649 |
| Vitamin B2 (Riboflavin 5) (P/L) | 0.0660 |
| Vitamin B12 Crystalline (P/L) | 0.0066 |
| Vitamin E Oil 93% FG | 0.4947 |
| Vitamin C (as Ascorbyl Polyphosphate (Stay C)) | 1.3193 |
| Bioastin Oleoresin (COS) | 0.1135 |
| Lucantin Pink (COS) | 0.0508 |

The final product is diluted in purified water as required. For example, when 4 kg of the phosphoric acid is used the final product is diluted in purified water to a final volume of 400 litres. These values for the final product include overage to ensure adequate amounts of the components over a 18 month period.

### EXAMPLE 2

| Material | % (Wt/Wt) |
|---|---|
| Phosphoric Acid (85% Food Grade) | 2.6430 |
| BHT P/L | 0.0264 |
| Monopropylene Glycol BP/000 (P/L) | 79.2885 |
| Polysorbate 80 (Alkamuls T80) | 13.2148 |
| Potassium Sorbate Powder BP | 2.6430 |
| Potassium iodide BP-USP (Nutec) | 0.0007 |
| Panthenol-D (P/L) | 0.0066 |
| Vitamin A Propionate 2.5 MIU | 0.0165 |
| Vitamin D3 Oil 4 MIU-G (P/L) | 0.0007 |
| Vitamin K | 0.0063 |
| Biotin USP Pure | 0.0007 |
| Choline Chloride 05 BP | 0.0132 |
| Inositol (P/L) | 0.0007 |
| Nicotinamide (Nutec - P/L) | 0.0694 |
| Para-Amino-Benzoic Acid (P/L) | 0.0660 |
| Pyridoxine Hydrochloride (Nutec - P/L) | 0.0073 |
| Vitamin B1 (Thiamine HCL) (P/L) | 0.1652 |
| Vitamin B2 (Riboflavin 5) (P/L) | 0.0073 |
| Vitamin B12 Crystalline (P/L) | 0.0066 |
| Vitamin E Oil 93% FG | 0.4956 |
| Vitamin C (as Ascorbyl Polyphosphate (Stay C)) | 1.3215 |

The final product is diluted in purified water as required. For example, when 4 kg of the phosphoric acid is used the final product is diluted in purified water to a final volume of 400 litres. These values for the final product include overage to ensure adequate amounts of the components over a 18 month period.

### EXAMPLE 3

| Material | Amount | |
|---|---|---|
| Vitamin B3 | 10000 | mg/kg |
| Vitamin B6 | 1000 | mg/kg |
| Vitamin B2 | 1000 | mg/kg |
| Vitamin B1 | 24000 | mg/kg |
| Vitamin B12 | 1280 | mg/kg |
| Vitamin A | 5300000 | iu/Kg |
| Vitamin D3 | 245500 | iu/kg |
| Vitamin E | 86000 | iu/kg |
| Vitamin C (as ascorbyl polyphosphate (Stay C)) | 180000 | mg/kg |
| Vitamin K | 1022 | mg/kg |
| Pantothanate | 850 | mg/kg |
| Choline | 1000 | mg/kg |
| Folic Acid | 5460 | mg/kg |
| Inositol | 29 | mg/kg |
| Biotin | 23 | mg/kg |
| Iodine | 26.1 | mg/kg |

Fe Gluconate may be added to the formulation at the rate of 17400 mg/kg as a source of dietary iron.

Marine algae may be added to the specification. These will supply a range of natural minerals and trace elements in addition to natural sources of proteins, lipids and carbohydrates. These include Glucides, mannitol, alginates and cellulose. Natural aglae are also a source of vitamins and may be used to supply some of the vitamins in the formulation.

Minerals supplied may include:
Calcium
Magnesium
Potassium
Sodium
Phosphorus
Sulphur
Iodine
Zinc
Manganese
Iron
Copper
Molybdenum
Selenium
Boron
Chromium
Nickel
Tin
Vanadium
Silica

Manufactured minerals and trace elements may be added to the formulation

### EXAMPLE 4

Includes the components provided in Example 1, including Bioastin Oleoresin (COS) and Lucantin Pink (COS), but does not include the listed vitamins and minerals.

### EXAMPLE 5

A composition as disclosed in Example 4 but 5 times more concentrated.

A study has been carried out in order to evaluate the ability of the compositions of the present invention (specifically, examples 1, 4 and 5) to enhance poor levels of carotenoid in frozen marine diets (TMC Brineshrimp, Mysis and Krill).

The compositions provided in examples 1, 4 and 5 were tested as follows: Test 1: 30 g of frozen marine feed were placed in a large weighing boat, to this 30 ml of the composition was added. After 30 minutes, 10 g of feed material was removed from the solution and blotted with absorbent material to remove any surface composition. 1 g of the blotted feed material in triplicate was then placed into test tubes.

A further 3 g of the blotted feed material was placed in a tea strainer and immersed in Tropic Marine seawater (1.024 @ 24° C.) for five seconds within a slightly turbulent flow. The contents were then blotted again, and a further 1 g in triplicate of test material was placed in test tubes.

The same procedure as above was repeated except the wash phase was for 15 seconds.

Using standard methods, each sample was analysed for total astaxanthin (a pre-hydrolysis of astaxanthin esters was used to base all findings on a ‘free’ astaxanthin basis). All samples were then run on a HPLC to determine astaxanthin content by an established method. Moisture content of the frozen marine diets was also established using the A.O.A.C (1990) methodology.

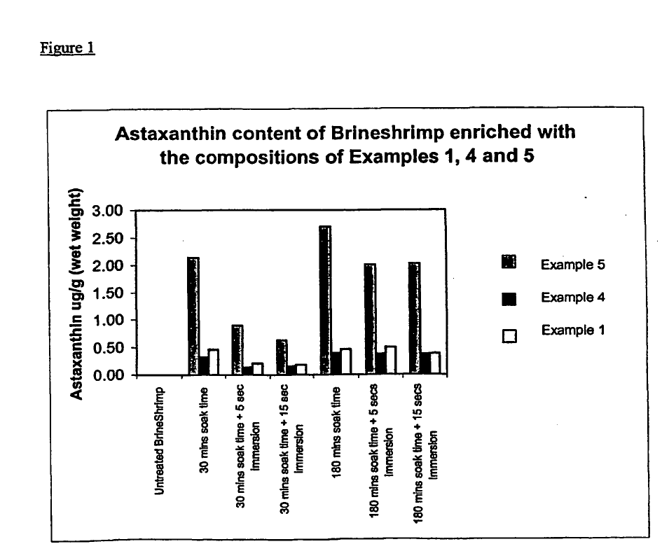

FIG. 1 (Brineshrimp subjected to soaking in the composition and subsequent immersion in seawater.) The first frozen marine diet tested was brineshrimp; this is the most widely used frozen feed supplement for tropical marine species. The brineshrimp tested had no trace of astaxanthin although there may have been traces of β-carotene (not confirmed by using beta carotene standard, but based on retention times of this particular carotenoid would suggest this was the carotenoid present). FIG. 1 clearly demonstrates the potential of all the compositions tested, each considerably boosting astaxanthin levels in the brineshrimp.

TABLE 1
(data presented in FIG. 1)

| | Example 5 | Example 4 | Example 1 |
|---|---|---|---|
| Brineshrimp (test procedure) | Ax present in μg/g | Ax present in μg/g | Ax present in μg/g |
| Untreated brineshrimp | n/f | n/f | n/f |
| 30 minutes soak time in product | 2.14 ± 0.71 | 0.33 ± 0.07 | 0.46 ± 0.05 |
| 30 minutes + 5 second wash | 0.89 ± 0.11 | 0.14 ± 0.06 | 0.21 ± 0.03 |
| 30 minutes + 15 second wash | 0.63 ± 0.23 | 0.16 ± 0.03 | 0.18 ± 0.04 |
| 3 hour soak time in product | 2.70 ± 0.18 | 0.40 ± 0.01 | 0.46 ± 0.07 |
| 3 hour + 5 second wash | 2.01 ± 0.45 | 0.38 ± 0.04 | 0.50 ± 0.08 |
| 3 hour + 15 second wash | 2.03 ± 0.05 | 0.38 ± 0.03 | 0.39 ± 0.07 |

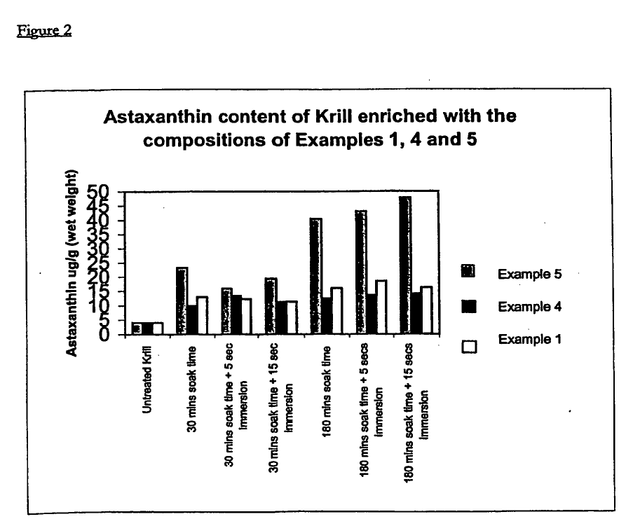

FIG. 2 (Krill subjected to soaking in the composition and subsequent immersion in seawater.) The second test was completed on frozen Krill. The main pigment found in krill is astaxanthin, although other carotenoid pigments are also found. The level of astaxanthin can vary among different krill products, but generally it is between 150-200 ppm on a dry weight basis. Astaxanthin is present generally in the esterified form. In contrast, synthetic astaxanthin, which is widely used in aquafeeds, is exclusively found in a non-esterified form. It is thought that the esterified form of astaxanthin must be converted to the free form prior to being absorbed from the gut.

TABLE 2
(data presented in FIG. 2)

| | Example 5 | Example 4 | Example 1 |
|---|---|---|---|
| Krill (test procedure) | Ax present in μg/g | Ax present in μg/g | Ax present in μg/g |
| Untreated krill | 2.96 ± 0.54 | 2.96 ± 0.54 | 2.96 ± 0.54 |
| 30 minutes soak time in product | 23.25 ± 0.34 | 9.92 ± 3.06 | 12.95 ± 4.44 |
| 30 minutes + 5 second wash | 15.97 ± 4.20 | 13.45 ± 0.84 | 12.38 ± 2.77 |
| 30 minutes + 15 second wash | 19.37 ± 0.75 | 11.30 ± 3.35 | 11.33 ± 0.70 |
| 3 hour soak time in product | 40.40 ± 2.85 | 12.45 ± 2.10 | 16.09 ± 3.94 |
| 3 hour + 5 second wash | 43.08 ± 0.60 | 13.69 ± 3.08 | 18.53 ± 1.61 |
| 3 hour + 15 second wash | 47.72 ± 3.20 | 14.06 ± 0.86 | 16.25 ± 0.38 |

The second biggest astaxanthin enhancement was achieved using frozen krill in conjunction with the tested compositions. Astaxanthin levels were elevated to almost eleven times the concentration in the basal frozen diet. This is depended on the composition used and the soak time.

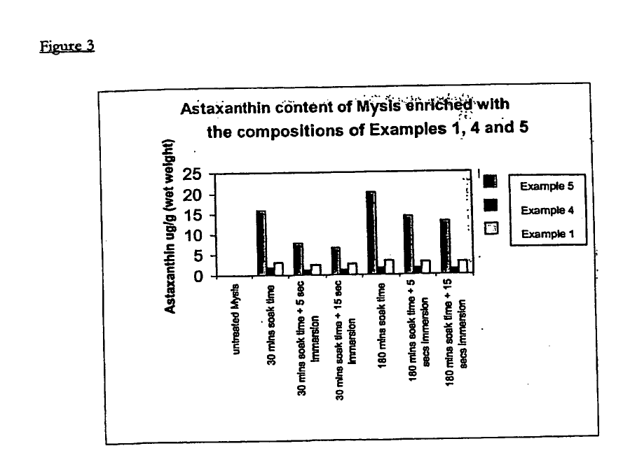

FIG. 3 (Krill subjected to soaking in the composition and subsequent immersion in seawater.)The final test focused on mysis shrimp. Similar to the brineshrimp they have a very poor carotenoid profile (analysis by HPLC confirmed this). The results detailed in FIG. 3 and table 3 show excellent enhancement with the tested compositions even after washing of the material in general.

TABLE 3
(data presented in FIG. 3)

| | Example 5 | Example 4 | Example 1 |
|---|---|---|---|
| Mysis (test procedure) | Ax present in μg/g | Ax present in μg/g | Ax present in μg/g |
| Untreated mysis | n/f | n/f | n/f |
| 30 minutes soak time in product | 15.90 ± 1.77 | 1.92 ± 0.24 | 3.16 ± 0.25 |
| 30 minutes + 5 second wash | 7.79 ± 0.53 | 1.24 ± 0.04 | 2.49 ± 0.22 |
| 30 minutes + 15 second wash | 6.60 ± 0.66 | 1.31 ± 0.19 | 2.75 ± 0.23 |
| 3 hour soak time in product | 20.22 ± 1.74 | 1.74 ± 0.37 | 3.46 ± 0.63 |
| 3 hour + 5 second wash | 14.35 ± 0.63 | 1.64 ± 0.08 | 3.12 ± 0.42 |
| 3 hour + 15 second wash | 13.14 ± 1.16 | 1.40 ± 0.33 | 3.15 ± 0.21 |

The results of these tests clearly demonstrate that there is retention of astaxanthin (carotenoid) in the tissue matrix of various marine zooplankton and invertebrate organisms. Accordingly the compositions of the current invention are particularly effective enrichment products for natural feed for marine/fresh water fish species.

Astaxanthin in the compositions are mainly in the esterified form (derived from for example Haematoccocus pluvalis) and is more effective than the synthetic ‘free’ form. Astaxanthin esterified to fatty acid acyl groups confer superior adsorption properties for tissues containing lipids as found in krill, mysis and adult brineshrimp.

The highest level of absorption and retention was attained in de-thawed frozen krill and the least adsorption was found in brineshrimp.

It should be stated that a significant background level of astaxanthin was measured in krill before soak treatment of the tested compositions. This was taken into consideration and is displayed in FIG. 2. Mysis had no prior astaxanthin level but responded well to the soaking treatment resulting in very good retention of carotenoid.

1-39. (canceled)

40. A composition comprising one or more carotenoids, and one or more of the following substances: vitamins, minerals, amino acids, lipids, peptides, nucleotides and/or polysaccharides.

41. A composition as claimed in claim 40, further comprising an aqueous diluent, wherein the composition is in the liquid state.

42. A composition as claimed in claim 40, wherein one or more of the components of the composition are water soluble.

43. A composition as claimed in claim 40, wherein one or more of the components of the composition is/are fat soluble.

44. A composition as claimed claim 41, wherein the fat soluble components are in the form of micelles.

45. A composition as claimed in claim 40, wherein the composition comprises one or more water soluble vitamins and one or more fat soluble vitamins.

46. A composition as claimed in claim 40, wherein the composition comprises one or more water soluble carotinoids and one or more fat soluble carotinoids.

47. A composition as claimed in claim 40, wherein the composition comprises one or more water soluble amino acids and one or more fat soluble amino acids.

48. A composition as claimed in claim 40, wherein the composition comprises one or more water soluble minerals and one or more fat soluble minerals.

49. A composition as claimed in claim 40, wherein the composition comprises one or more water soluble peptides and one or more fat soluble peptides.

50. A composition as claimed in claim 40, wherein the composition comprises one or more water soluble nucleic acids and one or more fat soluble nucleic acids.

51. A composition as claimed in claim 40, wherein the composition comprises an oil.

52. A composition as claimed in claim 40, wherein the composition comprises water soluble 1, 3 β-glucan or 1,6 β-glucan.

53. A composition as claimed in claim 40, further comprising cellulose, gum and or a sugar derivative.

54. A composition as claimed in claim 40, further comprising an emulsifier, preferably Polysorbate 80.

55. A composition as claimed in claim 40, further comprising a stabilising agent, preferably monopropylene glycol.

56. A composition as claimed in claim 40, further comprising a preservative, preferably phosphoric acid and/or potassium sorbate.

57. A composition as claimed in claim 40, further comprising an antioxidant other than a carotenoid, preferably ascorbyl polyphosphate and/or butylated hydroxy-toluene.

58. A composition as claimed in claim 40, wherein the inclusion of one or more carotenoid is optional.

59. A composition for enriching the diet of a captive species, wherein the composition is as claimed in claim 40.

60. A composition as claimed in claim 59, wherein the captive species are fish, preferably farmed fish, ornamental fish, or aquarium fish.

61. A composition as claimed in claim 59, wherein the composition is incorporated in feed.

62. A method for the enrichment of feed, comprising soaking the feed in a composition as claimed in claim 40.

63. A method as claimed in claim 62, wherein the feed is defrosting or defrosted.

64. A method as claimed in claim 62, wherein the feed is soaked in the composition prior to freezing.

65. A method for the enrichment of feed, comprising spraying the feed with a composition as claimed in claim 40.

66. A method for the enrichment of feed, comprising the addition of the composition as claimed in claim 40 before or during the production of processed feed.

67. A method for enrichment of feed, comprising the injection of the composition as claimed in claim 40 into the feed.

68. A method for enrichment of feed, comprising adding the composition as claimed in claim 40 to the environment or diet of live feed.

69. A feed comprising a composition as claimed in claim 40.
